(19) United States
(12) Patent Application Publication
(10) Pub. No.: US 2023/0125314 A1
(43) Pub. Date: Apr. 27, 2023

(54) STRAIN SENSOR ASSEMBLY

(71) Applicant: Koyo Bearings North America LLC, Greenville, SC (US)

(72) Inventors: Justin Brubaker, Greenville, SC (US); Robert Lukasiewicz, Simpsonville, SC (US)

(21) Appl. No.: 17/973,264

(22) Filed: Oct. 25, 2022

Related U.S. Application Data
(60) Provisional application No. 63/271,820, filed on Oct. 26, 2021.

(51) Int. Cl. G01L 1/22; G01B 7/16

(52) U.S. Cl. CPC G01L 1/2287; G01B 7/18

(57) ABSTRACT

An assembly for sensing an amount of strain in an object, including a first cup having a first end, a second end, a cylindrical side wall extending therebetween, and an end wall disposed at the first end of the first cup, and a strain wafer disposed on one of an outer surface and an inner surface of the end wall.

### CLAIM OF PRIORITY

This application claims priority to U.S. Provisional Patent Application No. 63/271,820 filed Oct. 26, 2021, the entire disclosure of which is incorporated herein.

### FIELD OF THE INVENTION

The present invention relates generally to sensors, and more particularly, to assemblies for measuring the amount of strain in an object.

### BACKGROUND OF THE INVENTION

As higher levels of automation are put in place, there becomes a need to replace signals and inputs normally processed by the human element to be processed by computers. This requires sensors to monitor components that are presently not monitored by instruments today, such as brakes, steering tie-rods, suspension arms and the like. In order to measure the load generated in these structures during use and send that signal to the computer, strain (sensors) wafers could be used. Some issues experienced with these elements are their fragility, difficulty in mounting, calibration, protecting, etc.

The present invention recognizes and addresses considerations of prior art constructions and methods.

### SUMMARY OF THE INVENTION

One embodiment of the present disclosure provides a strain sensor assembly for sensing an amount of strain in an object, including a first cup having a first end, a second end, a cylindrical side wall extending therebetween, and an end wall disposed at the first end of the first cup, and a strain wafer disposed on one of an outer surface and an inner surface of the end wall.

Another embodiment of the present disclosure provides a strain sensor assembly for sensing an amount of strain in an object, having a first cup having a first end, a second end, a cylindrical side wall extending therebetween, and an end wall including an inner surface and an outer surface disposed at the first end of the first cup, the end wall being one of arched or domed and having a convex surface and a concave surface, and a strain wafer disposed on one of an outer surface and an inner surface of the end wall.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which;

FIGS. 1A and 1B are perspective and cross-sectional views of an embodiment of a strain sensor assembly in accordance with the present disclosure;

FIGS. 2A, 2B, and 2C are a perspective view, a top view, and a cross-sectional view of the strain sensor assembly shown in FIG. 1A;

FIGS. 3A and 3B are cross-sectional views of an alternate embodiment of a strain sensor assembly in accordance with the present disclosure;

FIGS. 4A and 4B are perspective views of the strain sensor assembly shown in FIG. 1A and an alternate embodiment, respectively; and

FIG. 5 is a perspective view of a strain sensor assembly in accordance with an embodiment of the present disclosure inserted in a corresponding aperture of an object in which the strain is to be measured; and

FIGS. 6A and 6B are graphical representations of the amount of strain as measured in the direction along the longitudinal axis of the strain sensor assembly and the axis perpendicular to the cylindrical axis to the strain sensor assembly.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used herein, terms referring to a direction or a position relative to the orientation of the tappet assembly, such as but not limited to “vertical,” “horizontal,” “upper,” “lower,” “above,” or “below,” refer to directions and relative positions with respect to the assembly's orientation in its normal intended operation, as indicated in the Figures herein. Thus, for instance, the terms “vertical” and “upper” refer to the vertical direction and relative upper position in the perspectives of the Figures and should be understood in that context, even with respect to a tappet assembly that may be disposed in a different orientation.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provided illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

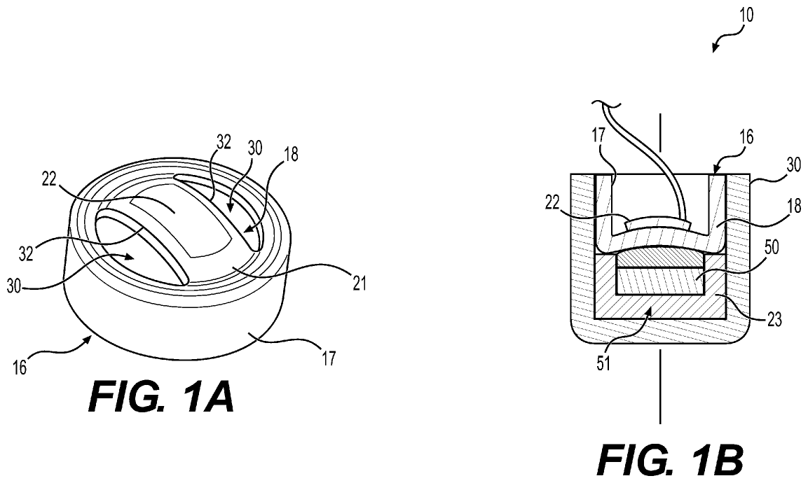

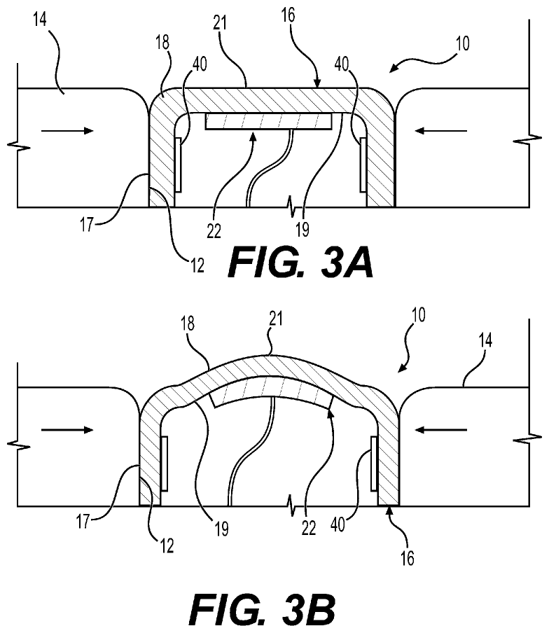

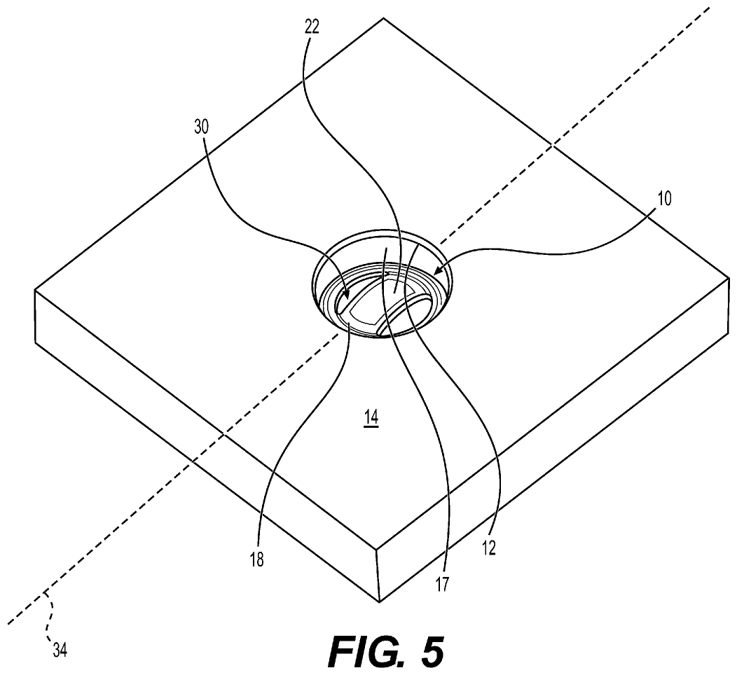

Referring now to the figures, specifically FIGS. 3A, 3B, and 5, this disclosure is related to a strain sensor assembly 10 utilizing drawn cup technology to construct a strain (load) sensor assembly 10 that can be slidably inserted into an aperture 12 defined in a corresponding object 14 to be monitored. Preferably, the strain measurement is taken off the end wall 18 of a cup 16, preferably a drawn cup. As shown in FIG. 1B, the cup 16 used for the measurement in this instance is an inner cup 16, which is pressed within another cup 30, or outer cup, with the volume defined between the end walls of the cups filled with silicone 23 or the like to create a robust package once instrumented and wired.

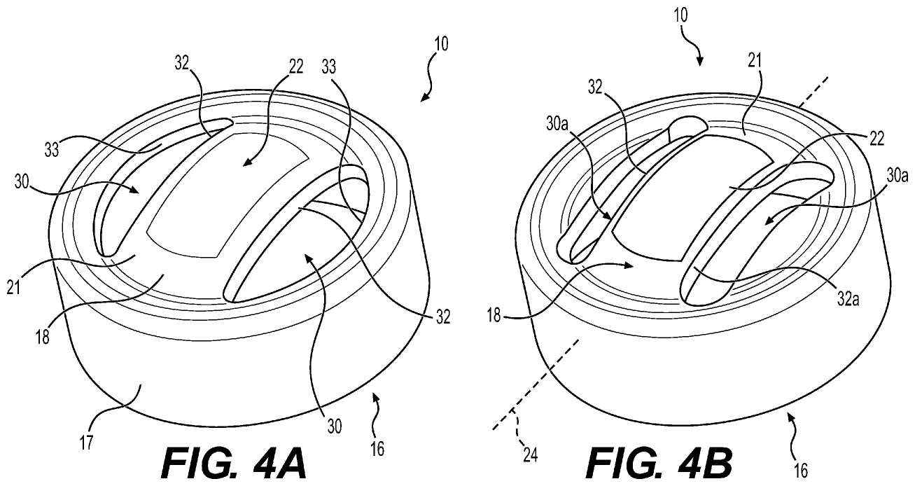

Referring now to FIGS. 1A and 4A, a strain sensor assembly 10 in accordance with a preferred embodiment of the present invention includes a drawn cup 16 including a cylindrical side wall 17 and an end wall 18. The end wall 18 has an inner surface 19 and an outer surface 21 that are configured to receive a strain wafer 22 thereon. As shown, the end wall 18 preferably includes a pair of elongated slots 30, each having a side wall 32 that is parallel to the corresponding side wall 32 of the other slot 30. As such, the end wall 18 includes a pair of parallel side walls 32 defined by the slots 30 to maximize the sensitivity of the strain sensor assembly to strain rates along the longitudinal center axis 34 of the end wall 18, as shown in FIG. 4B. As best seen in FIG. 4A, each end slot 30 is formed by substantially straight side edge 32 and a curved edge 33 that follows the contour of the cylindrical side wall, forming a half-moon shape.

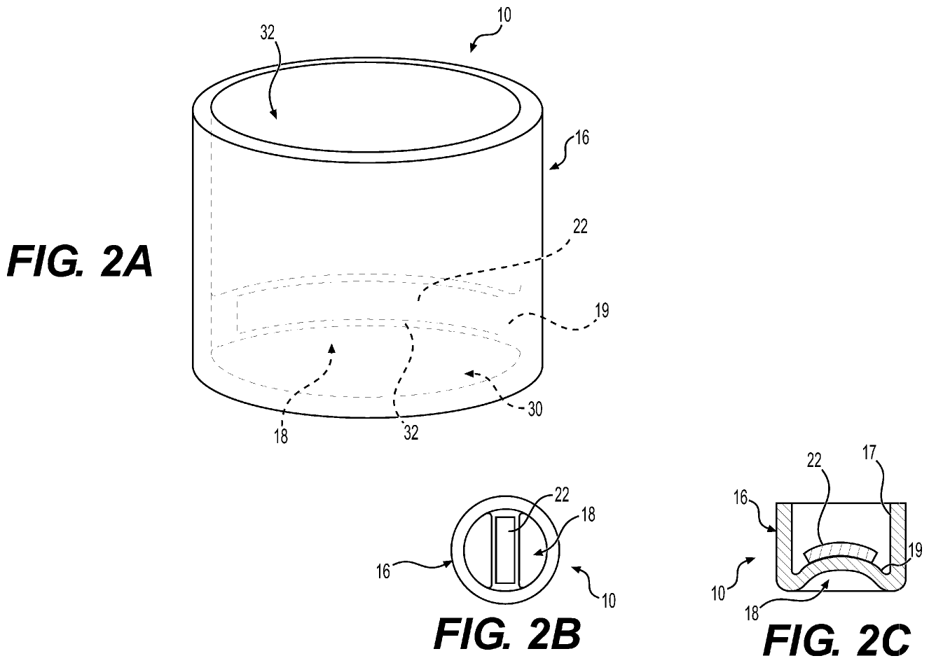

Alternate shapes of slots 30a, such as those shown in the embodiment of FIG. 4B, may be utilized. For example, the slots 30a shown in FIG. 4B include each slot 30a having a pair of parallel side walls 32a, with the slots 30a being parallel to each other. Note, in the embodiment shown in FIGS. 4A and 4B, the strain wafer 22 is adhered to the outer surface 21 of the end wall 18. Note also, referring additionally to FIG. 3B, the end wall 18 portion may be arched or domed, to increase the sensitivity to stress measurements along the longitudinal center axis 34 of the end wall 18. As shown in FIG. 3B, the strain wafer 22 may be adhered to the inner surface 19 of the end wall 18, rather than the outer surface 21, as shown in FIGS. 4A and 4B. Moreover, as shown in FIGS. 1B, and 2A through 2C, the end wall 18 may be arched inwardly into the inner cup 16 such that the outer surface 21 of the end wall 18 of the cup 16 is concave, rather than convex as shown in FIG. 3B.

The cup face 18 can be stamped or formed with a variety of shapes to focus on certain strain rates and directions, preferably along the longitudinal axis 34 of the end wall 18. As shown in FIGS. 3A and 3B, sensors 40 could be arranged around the cylindrical wall 17 of the cup 16 to sense torque within the corresponding object 14. Other sensors 50 could be placed within the volume 51 defined between the inner cup 16 and outer cup 30 to provide further information to the system, such as, but not limited to, temperature, acceleration, vibration, etc. As well, the void may be filled with a silicone, or like material, to help secure wiring, components, etc., to provide a robust assembly. Measurement of the amount of strain may be accomplished in a number of ways, for example: adhering strain wafers directly to the inside or outside of the end face, directly measuring change in resistance of the cup and/or cup face, and change in magnetism of the cup (magnetic-field sensing).

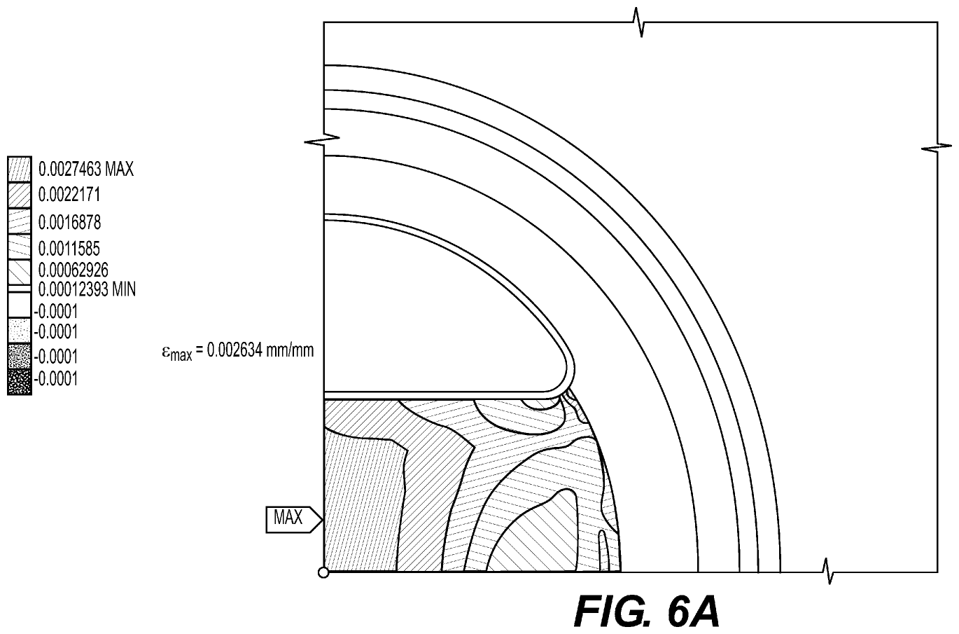

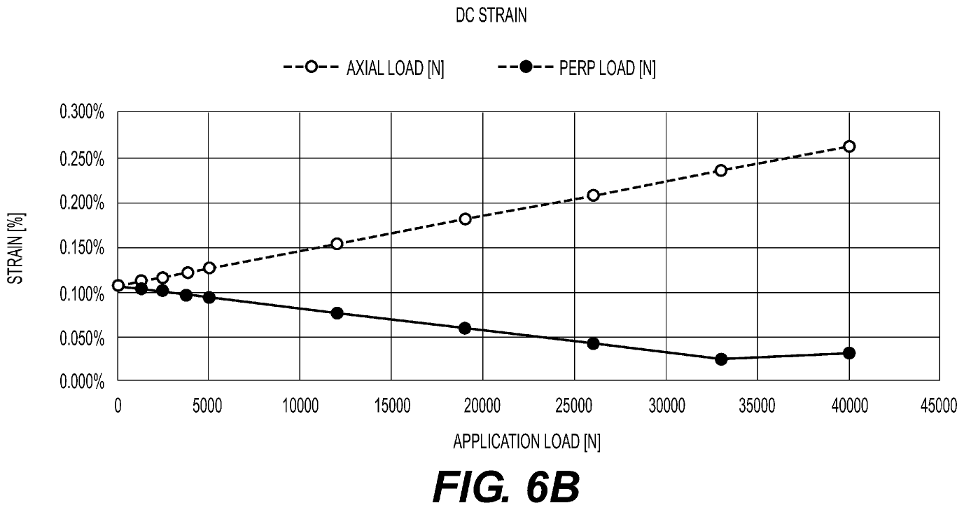

As shown in FIGS. 6A and 6B, the strain sensor assemblies 10 of the present disclosure are configured such that the measurement of strain in the object 14 is focused along the desired direction, that being along the longitudinal axis 34 of the strain wafer 22.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

1. A strain sensor assembly for sensing an amount of strain in an object, comprising:
a first cup having a first end, a second end, a cylindrical side wall extending therebetween, and an end wall including an inner surface and an outer surface disposed at the first end of the first cup; and
a strain wafer disposed on one of an outer surface and an inner surface of the end wall.

2. The strain sensor assembly of claim 1, wherein the end wall of the first cup includes a pair of parallel side edges, each side edge defining an aperture with the side wall of the first cup.

3. The strain sensor assembly of claim 2, wherein the end wall of the first cup is formed by an arch having a convex surface and a concave surface.

4. The strain sensor assembly of claim 3, wherein the outer surface of the end wall of the inner cup is the convex surface.

5. The strain sensor assembly of claim 4, wherein the first cup is slidably received in a cylindrical aperture defined in the object.

6. The strain sensor assembly of claim 5, wherein an outer diameter of the first cup is substantially the same as the diameter of the cylindrical aperture.

7. The strain sensor assembly of claim 4, further comprising a second cup having a cylindrical sidewall defining a central bore, wherein the first cup is slidably received in the central bore of the second cup.

8. The strain sensor assembly of claim 1, wherein the end wall of the first cup defines a pair of parallel slots, each slot including a pair of parallel side walls.

9. The strain sensor assembly of claim 8, wherein the end wall of the first cup is formed by an arch having a convex surface and a concave surface.

10. The strain sensor assembly of claim 9, wherein the outer surface of the end wall of the inner cup is the convex surface.

11. The strain sensor assembly of claim 9, wherein the first cup is slidably received in a cylindrical aperture defined in the object, and an outer diameter of the first cup is substantially the same as the diameter of the cylindrical aperture.

12. A strain sensor assembly for sensing an amount of strain in an object, comprising:
a first cup having a first end, a second end, a cylindrical side wall extending therebetween, and an end wall including an inner surface and an outer surface disposed at the first end of the first cup, the end wall being one of arched or domed and having a convex surface and a concave surface; and
a strain wafer disposed on one of an outer surface and an inner surface of the end wall.

13. The strain sensor assembly of claim 12, wherein the end wall of the first cup includes a pair of parallel side edges, each side edge defining an aperture with the side wall of the first cup.

14. The strain sensor assembly of claim 12, wherein the outer surface of the end wall of the inner cup is the convex surface.

15. The strain sensor assembly of claim 14, wherein the first cup is slidably received in a cylindrical aperture defined in the object, and an outer diameter of the first cup is substantially the same as the diameter of the cylindrical aperture.

16. The strain sensor assembly of claim 12, further comprising a second cup having a cylindrical sidewall defining a central bore, wherein the first cup is slidably received in the central bore of the second cup, and the strain sensor assembly is slidably received in a cylindrical aperture defined by the object.

17. The strain sensor assembly of claim 12, wherein the end wall of the first cup defines a pair of parallel slots, each slot including a pair of parallel side walls.
